(19) United States
(12) Patent Application Publication
(10) Pub. No.: US 2012/0210238 A1
(43) Pub. Date: Aug. 16, 2012

(54) DIRECT SERVICE LAUNCH ON A SECOND DISPLAY

(75) Inventors: Charles McCoy, Coronado, CA (US); Ling Jun Wong, Escondido, CA (US); True Xiong, San Diego, CA (US)

(73) Assignees: Sony Network Entertainment International LLC, Los Angeles, CA (US); Sony Corporation, Tokyo (JP)

(21) Appl. No.: 13/077,298

(22) Filed: Mar. 31, 2011

Related U.S. Application Data
(60) Provisional application No. 61/441,941, filed on Feb. 11, 2011.

(51) Int. Cl. G06F 15/16; G06F 3/01

(52) U.S. Cl. 715/738; 709/227

(57) ABSTRACT

Apparatus and methods to implement a technique for using a second display with a network-enabled television. In one implementation, this feature allows a user to directly launch a service when launching a second display application. In this way, the user is saved the trouble of having to search for the desired service in a list of services, reducing the difficulties of the systems disclosed above. The second display application may be a web application or a native remote controller application. The second display could be a smart phone that can often be found beside the user, or a laptop or tablet PC, a desktop PC, or the like.

### CROSS-REFERENCE TO RELATED APPLICATIONS

This application claims benefit of priority of U.S. Provisional Patent Application Ser. No. 61/441,941, filed Feb. 11, 2011, entitled “DIRECT SERVICE LAUNCH WHEN LOADING A WEB APPLICATION ON A SECOND DISPLAY”, owned by the assignee of the present application and herein incorporated by reference in its entirety.

### BACKGROUND

Internet delivery of digital content to IPTVs continues to increase, as does the popularity of IPTVs themselves. In these systems, content delivery is often performed from content service providers or just “services”, however, retrieving a service in a long list of services may become inconvenient over time, especially when the user accesses the same service on a regular basis. Current systems provide that, even for commonly-accessed services, the user is required to perform the manual action of going to the service list and selecting the service.

### SUMMARY

Systems and methods are provided that allow a user to directly launch a service when launching a second display application. The second display application may be a web application or a native remote controller application. In this way, the user is saved the trouble of having to search for the desired service in a list of services, reducing the difficulties of the systems disclosed above.

Variations of the systems and methods will also be seen. For example, instead of a web application or a native remote controller application, the user may also employ received parameters to perform a direct service launch as well. Such implementations may be useful when a user is passed URLs via e-mail, instant messaging, text messaging, and the like. In this implementation of the invention, the recipient need not search for the service in a list in order to load the same.

In one exemplary implementation, where the second display application is a web application, the following steps may be performed. When the web application is instantiated on a computing device, the service name or service identification of the desired service provider is added to a URL as a GET parameter. The GET parameter loads HTML code with the data required to load the service, this code is added to an autoexec variable in the web application. When the web application is instantiated, this variable is read and the web application is thus commanded to perform a direct launch of the desired service. In one implementation, on a server side, the service name or service identification is compared to a service list that may be retrieved when a device is selected. If the service is found in the list, the service is automatically launched as described and a landing page of that service is displayed. The autoexec variable may then be cleared to avoid being used again.

In another embodiment, the directly launched service could be made the target of a “HOME SERVICE” shortcut, such that, whenever the user selects a HOME SERVICE button, the second display application loads the corresponding service. On the other hand, if the service is not found, a service list may be presented so that the user can select a service to browse. If a direct service launch is successful, and the landing page is returned, the user may then browse the service for desired content.

Where the second display application is not a web application, analogous steps may be performed, but the same are then performed in the context of the native remote controller application.

In this way, the user can directly launch a desired or commonly-accessed service upon launch of the second display application. The user need not navigate through a list to the service, which depending on the number of services may become an arduous task.

Implementations of the invention may include one or more of the following. Besides launching a service, the system and method may also allow a user to directly launch a given page within a service, a category page within a service, a filtered page within a service, an asset, or a given point in an asset. The system may also launch websites, such as a registration website for a service. For purposes of such direct service launches, information may be stored in a cookie stored on the second display. Systems and methods may prompt a user as to whether a currently viewed or previously viewed service should be stored as a direct service launch.

Other implementations of the invention may provide that a direct service launch could launch to an advertisement so as to promote services or options within services.

The second displays serve as a visual aid to the IPTV, but generally do not require additional investment by the user because the same make use of a device, e.g., a smartphone, laptop computer, tablet computer, an internet appliance, etc., which most users would already have in their possession. Such a second display provides a complementary functionality to a content playback device such as an IPTV because of the second display's strength in supported languages and character font sets, data entry, processing power, and user experience in content management.

Where the second display application is a web application, the same may be scripting or non-scripting. The second display application may also be a Java application or any other sort of application that may communicate with a server. For example, the ASP/.NET framework with RPC can be employed to write the second display application. Where the web application running on the second display is written in HTML or HTML with Javascript, the same may be loaded by any device with a browser, and so the same is not limited to only a small set of compatible devices or expensive remote controls. Where a smartphone is employed, a mobile version of the second display user interface may be employed, with an appropriate listing of fields and an appropriate mobile resolution.

Communications with service providers may take place through a proxy server, and the proxy server presents to service providers the authentication credentials of the content playback device, so that the second displays appear to the service providers as authenticated content playback devices.

As noted above, the second displays may include any device that can run an application that communicates with a content playback device, including, but not limited to, personal computers, laptop computers, notebook computers, netbook computers, handheld computers, personal digital assistants, mobile phones, smart phones, tablet computers, hand-held gaming devices, gaming consoles, Internet appliances, and also on devices specifically designed for these purposes, in which case the special device would include at least a processor and sufficient resources and networking capability to run the second display application.

The content playback device can take many forms, and multiple content playback devices can be coupled to and selected within a given local network. Exemplary content playback devices may include IPTVs, DTVs, digital audio systems, or more traditional video and audio systems that have been appropriately configured for connectivity. In video systems, the content playback device includes a processor controlling a video display to render content thereon.

In a general method, a user employing a second display has a user account with a source or clearinghouse of services. Here, the source or clearinghouse is represented as a user account on a management server, but it should be understood that the user account may be with a service provider directly. The user account may have information stored thereon related to what content playback devices are associated with the user account. When a user logs on, they may see this list of content playback devices and may choose a particular content playback device. If there is only one content playback device on the network, or if the user is browsing in a way that the content playback device identity is not needed, then this step may be omitted. Moreover, a user may control content playback devices that are not included in a user account. For example, content playback devices may be discoverable and controllable, e.g., via infrared or Bluetooth® or the network or otherwise, that are not part of the user account with a management server or with a service provider. It may even be possible for a user to playback content on such a content playback device, if a service provider has made available content that can be delivered without access made to a user account.

Once a content playback device has been chosen, a list of services may be displayed. The list of services may be customized to those that have content playable on the chosen content playback device, or all available content may be displayed, in which case, e.g., a notation may be displayed adjacent the content item as to whether it is playable on the selected device.

Where no content playback device has been selected, all available content may be displayed. If no content playback device has been selected, but the user account includes stored information about which content playback devices are available, then all content may be displayed, a subset of all content may be displayed based on the known content playback devices associated with the account, or notations may be presented about which content playback devices can play which content, or a combination of these. In some cases, a content service provider may require a content playback device to be chosen so as to determine if content from that service provider may be played back. In other cases, no content playback device need be chosen and the user may simply choose and queue content for later playback by a content playback device to-be-determined at a later time.

Assuming multiple services are available, the user then selects a service to browse. In many cases, access to a service requires becoming affiliated with the service. Details of such affiliation processes are provided in U.S. patent application Ser. No. 12/982,463, filed Dec. 30, 2010, entitled “Device Registration Process from Second Display”, owned by the assignee of the present application and incorporated by reference herein.

Once the content playback device is affiliated with the services, the user may choose which service they wish to browse. Where a content playback device has not been chosen, the user may still choose services and browse, but the content offerings may be less specific to a given content playback device. The service presents a list of available content items. The presentation may be in any number of forms, including by category, by keyword, or in any other form of organization. The proxy server presents an authentication credential of the content playback device to the content server. In some cases, credentials for accessing the various services may be stored in the user account, and presented by the proxy server or management server to the content server when needed.

Individual services may employ their own DRM schemes which the current systems and methods may then incorporate. For example, if a video content service provider only allows a predetermined number of devices on which their content may be played back, then this rule may be enforced or duplicated within the context of the current system and method. Moreover, changes to such service provider rules or other parameters may be periodically polled for by the proxy server and/or management server, or the same may be polled for at a subsequent login of the service, e.g., at the time the affiliation is renewed. In other words, upon login, the system and method may poll for and receive a token associated with the given service provider, the token providing information to the system about the service provider as well is about the user account with the service provider.

The system and method may include a management server as mentioned above which, along with the content playback device, communicates with at least one content server such that the content server provides content items for presentation at the content playback device. The system and method may further include a proxy server communicating with the management server and the second displays. In some cases, the proxy server may be merged with the management server, or in other cases a separate proxy server may be provided for each content server or service provider.

In one aspect, the invention is directed to a method of directly launching a service upon instantiation of a second display application, including, upon instantiation of a second display application, establishing a session between a second display and a first server; retrieving an identifier of a service to be directly launched; using the identifier to load the service to be directly launched; and launching the service within the second display application.

Implementations of the invention may include one or more of the following. The second display application may be a web application, and the retrieving and using the identifier may include adding a URL corresponding to the identifier as a GET parameter; loading HTML code with the GET parameter; and adding the HTML code as an autoexec variable in the web application. The method may further include clearing the autoexec variable upon launch of the service. The method may further include displaying a prompt for a user to create a shortcut associated with the service to be directly launched, and upon user input, creating the shortcut. The identifier may be stored as a cookie. The second display application may be a native remote controller application. The session may be associated with the user account, and the user account may have associated therewith a plurality of services. The method may further include receiving and displaying a list of services associated with the user account. The method may further include retrieving data about a content playback device, and the retrieved identifier of a service to be directly launched may be in part determined by data corresponding to the content playback device. The data about the content playback device may be stored as a cookie. The identifier of a service to be directly launched may include category information, such that when the service to be directly launched is displayed for access on the second display, the displayed service is limited to the category. The service may be a website or may correspond to an advertisement. The identifier of a service to be directly launched may be created by, during a service browsing session, receiving an input from a user, the input indicating that a current service being browsed is to be designated as a service to be directly launched; and creating and storing an identifier corresponding to the service so designated. The second display may be a tablet computer, a smart phone, a laptop computer, a desktop computer, an internet appliance, or a computing device with internet access.

In another aspect, the invention is directed to a non-transitory computer-readable medium, including instructions for causing a computing device to implement the above method.

In a further aspect, the invention is directed to a method of directly launching a service upon instantiation of the second display application. Steps of the method include establishing a session between a second display and a first server, receiving an identifier of a service to be directly launched, and comparing the identifier of the service to be directly launched with a plurality of services. If the identifier of the service to be directly launched corresponds with a service in the plurality, then a signal is transmitted to the second display to cause the second display to launch the service corresponding to the identifier. If the identifier does not correspond, then a list of the plurality is displayed on the second display, or a browser on the second display is caused to load and launch a registration website for the service corresponding to the identifier.

Implementations of the invention may include one or more of the following. The second display application may be a web application, and the identifier of a service to be directly launched may include a URL corresponding to the service, where the transmitted signal includes JavaScript code. The second display application may be a native remote controller application. The identifier of a service to be directly launched may include category information, such that when the service to be directly launched is caused to be displayed on the second display, the displayed service is limited to the category. Upon receipt of the identifier of the service to be directly launched, an advertisement may be retrieved that is associated with the identifier of the service. The advertisement may then be launched on the second display. The second display may be a tablet computer, a smart phone, a laptop computer, a desktop computer, an internet appliance, or a computing device with internet access. The session may be associated with the user account, and the user account may have associated therewith a plurality of services.

In another aspect, the invention is directed to a non-transitory computer-readable medium, including instructions for causing a computing device to implement the above method.

Advantages of certain embodiments of the invention may include one or more of the following. A user can directly launch a desired or commonly-accessed service upon launch of a second display application. The user need not peruse or comb through a potentially lengthy list of service providers in order to locate a desired service.

Other advantages will be apparent from the description that follows, including the figures and claims.

### BRIEF DESCRIPTION OF THE DRAWINGS

Like reference numerals denote like elements throughout.

FIG. 1 is a block diagram of an exemplary system in accordance with one aspect of the present principles.

FIG. 2 is a sequence diagram illustrating a method according to another aspect of the present principles.

FIG. 3 is a flowchart illustrating an exemplary method according to a further aspect of the present principles.

FIG. 4 is a flowchart illustrating an exemplary method according to another aspect of the present principles.

FIG. 5 is a block diagram of an exemplary second display system in accordance with another aspect of the present principles.

FIG. 6 is a flowchart illustrating an exemplary method according to another aspect of the present principles.

FIG. 7 is a block diagram of an exemplary second display in accordance with another aspect of the present principles.

FIG. 8 is a block diagram of an exemplary server in accordance with another aspect of the present principles.

FIG. 9 illustrates an exemplary computing environment, e.g., that of the second display, proxy server, management server, or content server.

### DETAILED DESCRIPTION

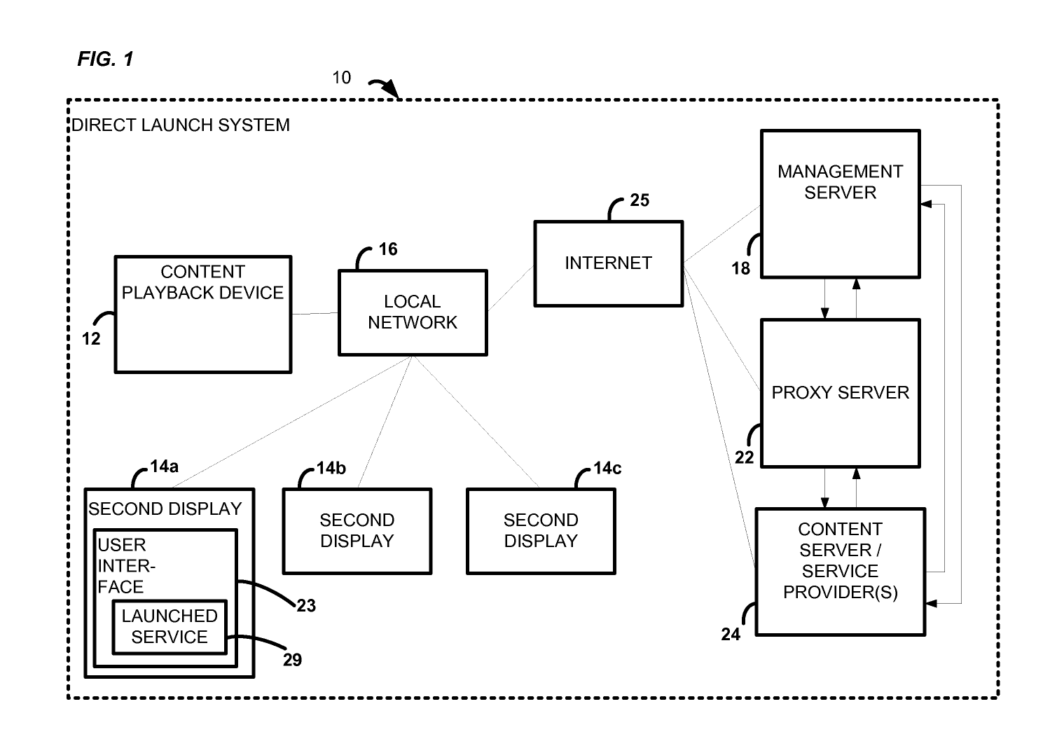

Referring initially to FIG. 1, a direct launch system 10 is shown including a content playback device 12 coupled to a local network 16, which may be wired, wireless, or a combination of both. Also coupled to the local network 16 are one or more second displays 14a-14c, an exemplary one of which is termed second display 14i. A number of servers may be accessed by the content playback device 12 and the second display 14i through the local network 16 and the internet 25, including a management server 18, a proxy server 22, and one or more content servers 24 corresponding to service providers (only one is shown in FIG. 1).

The second display 14a includes a user interface 23 for a second display application which when launched may in turn launch, automatically or after a user prompt, a service 29. For example, if a user often watches content from a particular service, the user can set that service as the service to be launched. Variations will be seen. For example, the service 29 may launch at its home page, at a category screen, at an asset, especially where the asset provides a constant stream of content, or at other such locations.

Where the service launches a category screen or a homepage of the service, the same may be displayed on the second display user interface 23 or on the content playback device 12. Where the service launches an asset, the same is generally displayed and played back on the content playback device 12, although in some cases, the same may be shown on the second display 14a.

An authentication credential of the content playback device may also be logged with the user account, this credential often required for access to services and content items. The service to be launched may access the authentication credential, or receive the same from the content playback device, if required to launch the service.

Using the system 10 of FIG. 1, a user of the second display 14a is provided with a convenient way to directly initialize or launch a preferred service. In this way, the user is saved the inconvenience of having to navigate to the preferred service, which in some implementations may have otherwise required the user to navigate through a long list of services. The convenient and flexible user interface 23 of the second display 14a may then be leveraged to choose content from the service provider for the content playback device 12.

Details of individual components are now described.

The content playback device 12 may be, e.g., an IPTV, a digital TV, a digital sound system, a digital entertainment system, a digital video recorder, a video disc player, a combination of these, or any number of other electronic devices addressable by a user on the local network 16. For the sake of simplicity, in this specification, the content playback device 12 will generally be exemplified by an IPTV, in which case it will typically include a processor that controls a visual display and an audio renderer such as a sound processor and one or more speakers. The processor may access one or more computer-readable storage media such as but not limited to RAM-based storage, e.g., a chip implementing dynamic random access memory (DRAM), flash memory, or disk-based storage. Software code implementing present logic executable by the content playback device 12 may also be stored on one of the memories disclosed below to undertake present principles. The processor can receive user input signals from various input devices including a remote control device, a point-and-click device such as a mouse, a keypad, etc. A TV tuner may be provided in some implementations, particularly when the content playback device 12 is embodied by an IPTV, to receive TV signals from a source such as a set-top box, satellite receiver, cable head end, terrestrial TV signal antenna, etc. Signals from the tuner are then sent to the processor for presentation on the display and sound system. A network interface such as a wired or wireless modem communicates with the processor to provide connectivity to the Internet through the local network 16. It will be understood that communications between the content playback device 12 and the internet 25, or between the second display 14i and the internet, may also take place through means besides the local network 16. For example, the second display 14i may communicate with the content playback device 12 through a separate mobile network.

The one or more second displays 14a-14c each bear a processor and components necessary to operate an application for, e.g., service provider and content selection, as well as a direct launch of a service. In particular, the processor in the second display may access one or more computer-readable storage media such as but not limited to RAM-based storage, e.g., a chip implementing dynamic random access memory (DRAM), flash memory, or disk-based storage. Software code implementing present logic executable by the second display may also be stored on one of the memories disclosed below to undertake present principles. Further, the second display 14i can receive user input signals from various input devices including a point-and-click device such as a mouse, a keypad, a touchscreen, a remote control, etc. A network interface such as a wired or wireless modem communicates with the processor to provide connectivity to the local network and to wide area networks such as the Internet as noted above.

The servers 18, 22, and 24 have respective processors accessing respective non-transitory computer-readable storage media which may be, without limitation, disk-based and/or solid state storage. The servers communicate with a wide area network such as the Internet via respective network interfaces. The proxy server 22 may in some cases be combined with the management server 18, although in many cases it may be preferable to separate the servers to better accommodate server load. The servers may mutually communicate via the internet 25. In some implementations, the servers may be located on the same local network, in which case they may communicate with each other through the local network without accessing the internet. For example, in one exemplary implementation, the management server 18 and the proxy server 22 may be disposed in the same data center, so communication between the two may stay within the data center.

While an exemplary method of the system is described below, certain method steps especially pertinent to certain arrangements of the second display will be described here.

Responsive to the second display 14i sending a request to the proxy server 22 for an executable utility, the proxy server 22 returns the utility to each second display 14i. Running the utility causes the instantiation of an application. The implementation discussed here includes a web application, but it will be understood that other types of applications may also be employed as described above.

The second display 14i, executing the web application, prompts a user to input to each second display 14i login information. The login information may be common or may differ between second displays. The proxy server 22, responsive to reception of correct login information from the content playback device 12, returns the local IP address of the content playback device 12 to the second display 14i, because the same has previously been registered to a user account in which such information is maintained. The proxy server 22 may also return a list of content playback devices on the local network, responsive to which the second display 14i may select one for content playback. In turn, each second display 14i uses the local content playback device address to access the content playback device 12 directly to request information about the content playback device 12, which information is returned from the content playback device 12 to the second display 14i such that the local address of the content playback device 12 need not be globally addressable. Each second display 14i may also select content for playback on different content playback devices. The second display 14i sends the information about the content playback device 12 to the proxy server 22, requesting a list of services available to the content playback device 12 from one or more service providers. The services may be dependent on the device characteristics of the content playback device 12 chosen. For example, if the chosen content playback device 12 is an IPTV, video services may be returned. If the chosen content playback device 12 is an audio system, audio services may be returned.

The proxy server 22 relays the request for a list of services to the management server 18, which returns the list to the proxy server 22, with the proxy server 22 in turn sending the list to the second display 14i for presentation of information on the second display 14i. Responsive to a user selection of an item on the list, the second display 14i sends a request for a software asset corresponding to the selected content item to the proxy server 22. The proxy server 22 requests a service login of the content server 24 providing the content, and the content server 24 provides to the proxy server 22 a list of content items, assets, categories, or services, and the proxy server 22 relays the list to the second display 14i, which is presented on the second display 14i so that the user can navigate to enter a selection. Responsive to the selection, the second display 14i sends a command to the content playback device 12 to access and play back the selection.

The command to play the local content item may be in a number of forms. The second display 14i may communicate to the proxy server 22 the request on behalf of the content playback device 12, and this request may be via the local network or via other means. Alternatively, the second display 14i may transmit a request to the content playback device 12 that it itself formulates the request, and this transmission may be by way of the local network, the internet generally, or via other means such as other wired or wireless transmission schemes, including via USB, IR, Bluetooth®, or any other schemes. If the second display 14i is configured to address the content playback device 12 at a non-local level, e.g., at the server level, then the second display 14i may be physically located virtually anywhere and still be able to queue content or to command the content playback device 12 to play content. In this case, however, server load would increase over the case where the second display and content playback device communicated directly or over a local network.

Certain method steps of an arrangement of the content playback device are described here. Using a network interface, the content playback device 12 can communicate with a management server 18 on the Internet and with one or more content servers 24, also on the internet and communicating with the management server 18. The management server 18 receives and stores a local IP address of the content playback device 12. The content playback device 12 communicates with the management server 18 to arrange for content items from the content server 24, operated by a service provider, to be played back on the content playback device 12. In more detail, in one embodiment, the content playback device 12 sends login information to the management server 18 which returns to the content playback device 12 a user token that must subsequently be presented by the content playback device 12 to the content server 24 to obtain content from the content server 24.

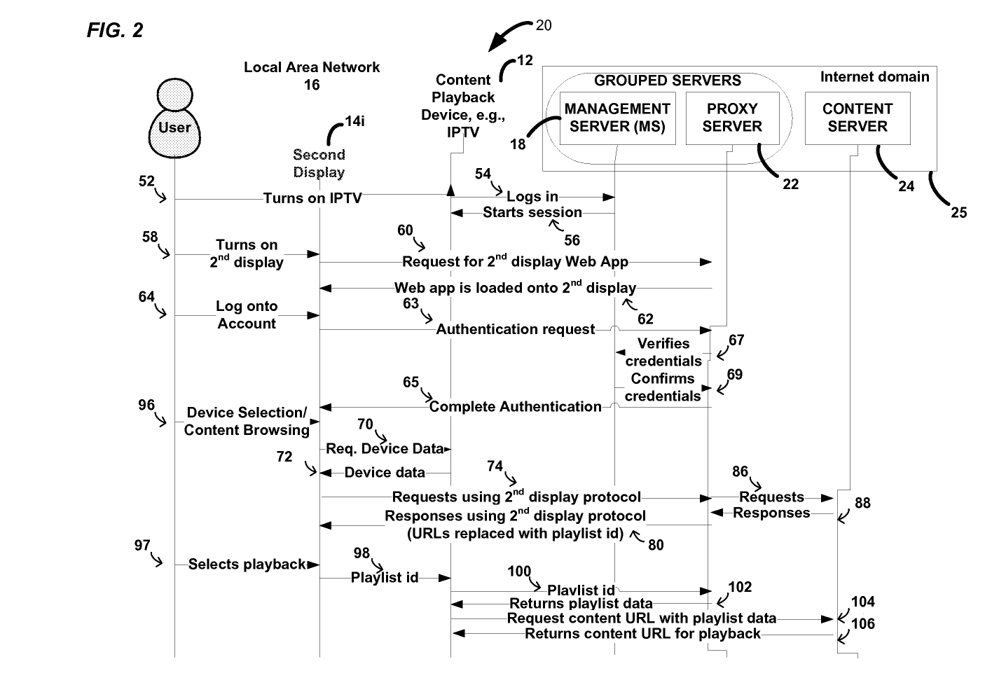

FIG. 2 is a sequence diagram illustrating an exemplary implementation of a method for enabling a user to employ a second display to browse content playback devices, service providers, content items and select the same for playback by a content playback device. FIG. 2 assumes that the user has already created an account with a management server and has affiliated one or more content playback devices with that account.

At state 52, a user turns on the content playback device 12. At state 54 the content playback device sends login information including, e.g., username and password, to the management server 18, which at state 56 returns to the content playback device a user token that may subsequently be presented by the content playback device to a content server 24 to obtain content from that server. The management server 18 in addition stores the local IP address of the content playback device 12.

At state 58, the user turns on the second display 14i and instantiates a web browser session in which control may be exercised over the content playback device. Other types of sessions may also be employed as has been noted. A utility is executed on the second display 14i, at state 60, which sends a request to the proxy server 22, which returns in state 62 a web application, e.g., HTML with JavaScript, for the second display to execute for browsing services and content items. This application may make, e.g., asynchronous JavaScript and XML calls to the proxy server 22 and to the content playback device 12 to obtain information to control the content playback device 12.

At state 64, using the JavaScript received from the proxy server 22, the second display 14i prompts the user to input to the second display 14i the account login information, including, e.g., the same username and password that the content playback device provided to the management server 18 in state 54 during device registration. Of course, the account login information may differ as well. It will be appreciated that the servers 18, 22, and 24 communicate necessary account information between them as needed to realize the principles described here.

The proxy server 22 responds to a correct user name and password from the second display 14i in an authentication request state 63. The proxy server 22 verifies the user name and password with the management server 18 (states 67 and 69), creates and transmits a session token to the second display, obtains information about content playback devices affiliated with the user account, and completes the authentication in state 65. The proxy server 22 may return to each second display the information about all content playback devices 12 that are affiliated with the user account associated with the user name and password, including their local IP addresses which were stored by the management server 18 after login at 54 (and subsequently provided to the proxy server 22). In more detail, the proxy server 22 sends a token to the second display 14i, the token associated with a content playback device, and this token gets communicated in future transactions between the second display and the proxy server, so that the proxy server 22 knows what content playback device the content item is intended for. Each user with each second display may then choose a content playback device and browse the services and content options available through the services in state 96 and subsequent steps.

The second display 14i, using the local IP address returned as noted above, accesses the content playback device directly, in the sense of communicating through the local network. To select a particular content playback device, the second display 14i requests information about the content playback device 12 at state 70, including language information, digital rights management (DRM) information, etc., as desired, which information is returned from the content playback device to the second display 14i at state 72. Since the second display 14i knows the IP address of the content playback device 12 and consequently communicates directly with the content playback device 12, the second display 14i communicates using a local web address of the content playback device 12 that need not be globally addressable, and may so communicate as long as the second display 14i and content playback device 12 are on the same local network.

Each second display 14i may send the client information received at state 72 to the proxy server 22, requesting a list of services available to the content playback device 12, or that the content playback device 12 is entitled to, from one or more of the content servers 24. The proxy server 22 relays the request to the management server 18, which returns the requested service list to the proxy server 22. The proxy server 22 in turn sends the services list to the second display for presentation of available services on the second display. Each user browses the services and their content on the second display just as though it were the actual content playback device.

A user can input, using, e.g., a second display input device, a selection of a service on the list that was returned to the second display. In response, the second display, at state 74, sends a request for the corresponding service to the proxy server 22 along with the service token that that second display may have received from the content server 24 via the management server 18.

Responsive to the request, the proxy server 22 requests a service login at state 86 of the content server 24 providing the selected service. At state 88, the content server 24 provides to the proxy server 22 a list of content items, assets, categories or services, as the case may be, for the particular content server 24. If desired, the proxy server 22 may also request of the content server 24 a list of options, and the list may be returned in, e.g., extended markup language (XML) format to the proxy server 22 which relays the content items, assets, categories, services, etc. available for selection to the second display at the state 80.

The content available for selection is presented on the second display so that the user can navigate (in state 97) the display to enter a selection. Responsive to the selection, the second display at state 98 sends a command to the content playback device 12 to play the selection, and in particular sends a playlist id or reference identifier indicating the selection. At state 100, the content playback device 12, using its authentication credentials, sends the playlist id or reference identifier to the proxy server 22, which returns the required playlist data in state 102. The content playback device 12 can then request the content URL with the playlist data in state 104, which may be responded to with a return of the content URL for playback of the content item on the content playback device 12 in state 106.

Variations of the system and method are now described.

If the content playback device were already playing content, the new content commanded to be played by the second display may be placed in a queue in the content playback device and played when the current content completes. In any case, once the content has been commanded to be played, the user may continue to browse the second display for other content, to play or to add to the queue. Other users may employ their own second displays to do the same. A user may also desire to switch devices and resume playback on a different device by, e.g., navigating to a “recently viewed” list and selecting the last video played after switching control to the desired device.

The above description has been for the case where the proxy server 22 is employed to hide the content source, e.g., a content URL, from the second display 14i. That is, the proxy server 22 provides an API for the second display to use so that the content and/or content URL cannot be accessed directly. In this way, the details of the management server transactions to access the services remain desiredly unknown. In many cases, the second display 14i may have stored thereon little or no details about the content playback device 12. In some cases, however, the URL may be directly provided from the proxy server 22 or the proxy server 22 may even be bypassed, e.g., in cases where the content item is intended for free distribution, e.g., movie trailers or the like. Similarly, while the above description has focused on content item playback on content playback device 12, certain content items, e.g., those which are intended for free distribution, may be played back on the second display 14i itself, if the same has been appropriately configured.

In the case where multiple second displays request content to be played at or near the same time, a simple rule such as the first-in-time may prevail. Alternatively, a priority scheme may be configured, such that certain second displays take precedence over other second displays. Alternatively, a plurality of user profiles may be employed, and precedents may be based on the identity of specific users.

The control device may command the content playback device to play content by sending, to the content playback device over the local network, commands coded as if they were sent from an infrared remote control, e.g., the commands may be in the Sony Infrared Remote Control System (SIRCS) protocol.

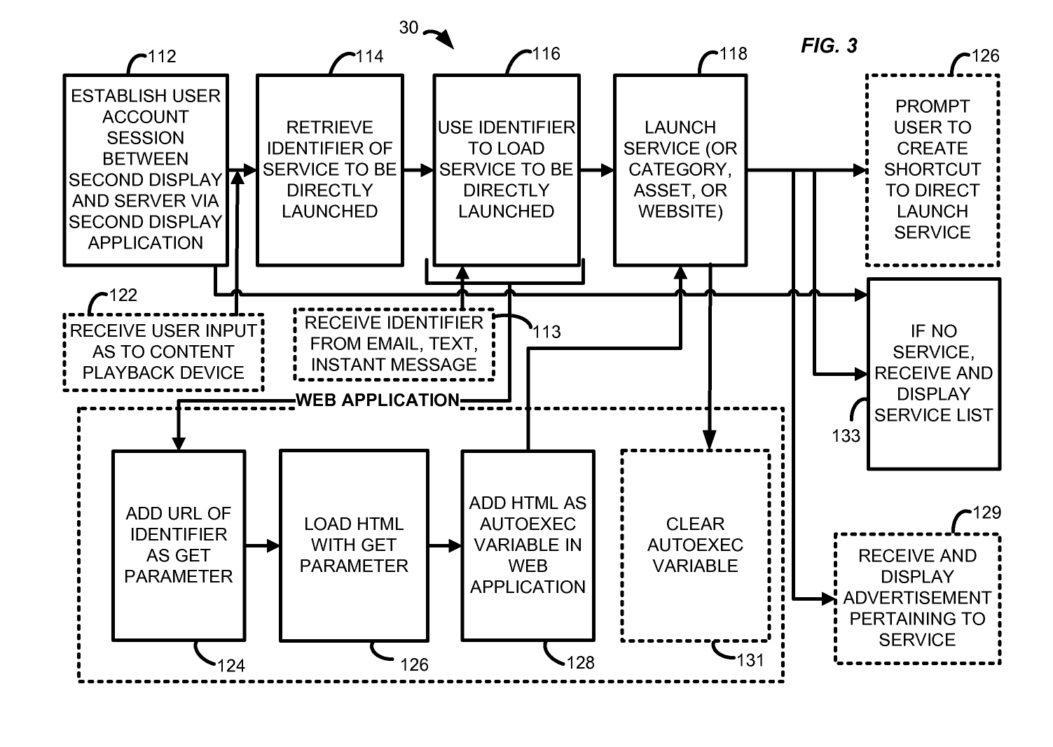

FIG. 3 illustrates an exemplary method 130 by which a direct service launch may be performed. The method 130 may especially pertain to steps performed by a second display.

A first step is the establishment of a user account session between a second display and a server, e.g., via a second display web application (step 112). As noted, however, this step need not occur via a web application per se. Rather, the second display may employ a native application with which to contact and negotiate with the server. The session is generally associated with a user account, and may include entering logon credentials such as a username and password. Other variations will also be understood. The server itself may be a management server, a proxy server, or the like.

An optional step is to provide a means for a user to choose a content playback device (step 122). That is, the user account may have information stored thereon about which content playback devices are associated with the user's system, or alternatively content playback devices may be discovered, e.g., on the local network or via a direct wireless discovery such as via infrared or Bluetooth®. Once discovered, devices not previously associated with the user's account may be registered, which in the process creates an affiliation with the user's account.

Step 122 provides a means for the user to choose a content playback device. If step 122 is employed, the direct service launch may be specified to each content playback device. In other words, each content playback device may have a different directly-launched service. In an alternative embodiment, each category of content playback device, e.g., IPTV, audio receiver, and so on, may have an associated directly-launched service. In yet a further embodiment, the user may have stored one or more preferred content playback devices, and the identity of the stored content playback devices may be employed for this purpose.

Alternatively, no content playback device may be chosen or stored for this purpose. In this case, instantiation of a second display application may lead to the directly-launched service starting up, without regard to whether content from the directly launched service may be played back on the user's content playback devices. In an alternative embodiment, a user may enter a different chosen directly-launched service for each category of content playback device, as well as an order of preference from among the directly-launched services. Upon instantiation of the second display application, the system may poll available content playback devices to determine what types are available. Using this information, the system may display the most preferred directly-launched service from among the available categories of content playback devices.

Where the service is also configured as an asset, the service may be launched directly on one or more of the user's content playback devices appropriate to that service, or even on all. For example, a user may desire that a music service be directly launched and provide playback on all or a portion of the available audio systems.

In another alternative embodiment, a number of user profiles may be associated with the user account, and each user profile may have its own directly-launched service.

Combinations of the above systems will also be seen.

A next step is to receive or retrieve an identifier of the service to be directly launched (step 114). The identifier may be in a number of forms, e.g., stored as a cookie (or in any other sort of retrievable data format) on the second display 14i. Alternatively, the identifier may be stored on the server; however, in that case a step of retrieving the identifier from the server would be required.

A next step is to use the identifier to navigate to the service to be directly launched (step 116). In this step, information about the identifier is used to generate the URL for the service, and the URL is loaded into the browser of the second display. The service may then be launched (step 118). As noted above, various points within the service may be used as entry points, e.g., the homepage of the service may be launched, a category within the service may be displayed, an asset may be launched, or the like.

Where the second display is a web application, step 116 may include steps of adding a URL corresponding to the identifier as a GET parameter (step 124). The identifier itself may include information of the URL, or the URL may be retrieved from knowledge of the identifier using a lookup table or in any other known manner. Following step 124, HTML code may be loaded with the GET parameter (step 126), and this HTML code may be added as an autoexec variable in the web application of the second display (step 128). Running the second display web application then automatically launches the service, as in step 118. Following launch, and optional step is to then clear the autoexec variable to avoid the same being used again (step 131).

Also following launch, a user may be prompted to create a shortcut to the service (step 126). In this way, the directly launched service may be conveniently accessed at any point in the future by activating the shortcut. Such a shortcut may be termed a “HOME SERVICE” shortcut, and in this way whenever a user selects the HOME SERVICE button, the second display application loads the desired service.

If the service corresponding to the retrieved identifier is off-line, no longer exists, or is otherwise inaccessible, rather than just returning an error message, a step may be performed of displaying a list of other services affiliated with the user account (step 133). This step may also be performed if the user has not configured their system in such a way as to store information about a service to be launched.

In another variation, the service to be directly launched may be configured such that upon launch, rather than displaying the home screen, the user may be presented with an advertisement (step 129), e.g., on a splash screen or otherwise. In this case, a link may be provided to the service from the advertisement or in certain cases the second display application may be directed to the service site itself, or to the presence of the service on a management server domain. More details of this variation are discussed below in connection with steps performed by the server.

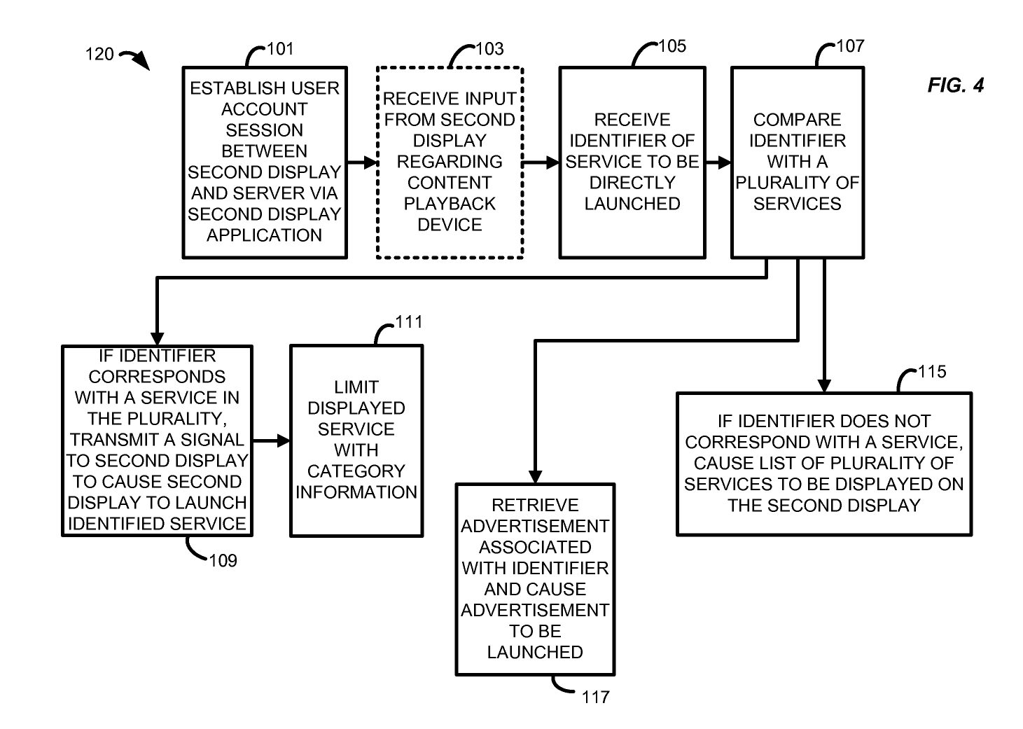

Referring to FIG. 4, a flowchart 120 is illustrated representing exemplary steps which may be performed by a server according to present principles. Some steps have similarity with steps in FIG. 3, and the same represent the “server side” of the same steps.

A first step is to establish a user account session between a second display and the server (step 101). In this step, the second display attempts to communicate with the server, and the server takes the steps necessary to establish the user account session.

In an optional step, the server may receive input from the second display regarding which content playback device is to playback content (step 103). If this step is employed, the service launched may be based at least in part on the chosen content playback device.

A next step is to receive at the server an identifier of a service to be directly launched (step 105). Details of this identifier are described above in connection with FIG. 3. The server may then compare the received identifier with a plurality of services (step 107), e.g., those associated with the user account. If the identifier does not correspond with any services in the plurality, the plurality of other services associated with the user account may be caused to be displayed on the second display (step 115). The user may then choose a service in which to browse, and that service may then be launched.

In an alternative embodiment, if the service does not correspond with a service in the plurality, the user may be directed to a registration page for the service, and the user may sign up for the service thereby. The registration page may be a page associated with the service provider, a page hosted by the management server, a page hosted by a third party server, or the like.

In many cases, where the service to be directly launched is one stored by the user, the service will be found in the plurality of services associated with the user account. However, situations exist where this is not the case. For example, a service to be directly launched may be passed to the user by another user, such as in an e-mail, instant message, text message, or the like (step 113). Using the systems and methods described here, the user may activate a link in the received message, causing the second display application to instantiate and directly launch the service, negating the need for the user to look for the service in a list of services and load the same in a manual fashion.

In the general case, where the identifier corresponds with a service in the plurality, a signal may be transmitted to cause the second display to launch the identified service (step 109). In some cases, where a user has identified a particular category within the service to be of interest, the displayed listings may be limited to the category desired (step 111) or a separate category page within the service may be displayed instead.

In another implementation, a step may be performed in conjunction with any of the steps listed above. In particular, the received identifier may correspond to a service which has been configured to display, along with or instead of displaying a landing page for the service, an advertisement associated with the service (step 117). The advertisement may be part of a splash screen or other such notification to the user. For example, in the implementation described above in which a service is not found in a plurality of services associated with a user account, an advertisement may be displayed to introduce the user to the service. In another implementation, an advertisement may be displayed introducing a user to a portion of the service they may not be aware of. In this case, a link may be provided to the service from the advertisement, or in other implementations, the second display application may be directed to the service site itself, or a presence of the service on the management server domain.

Portions of steps 111 and 117 may be performed by or in conjunction with a service provider.

Aspects of various components are described below.

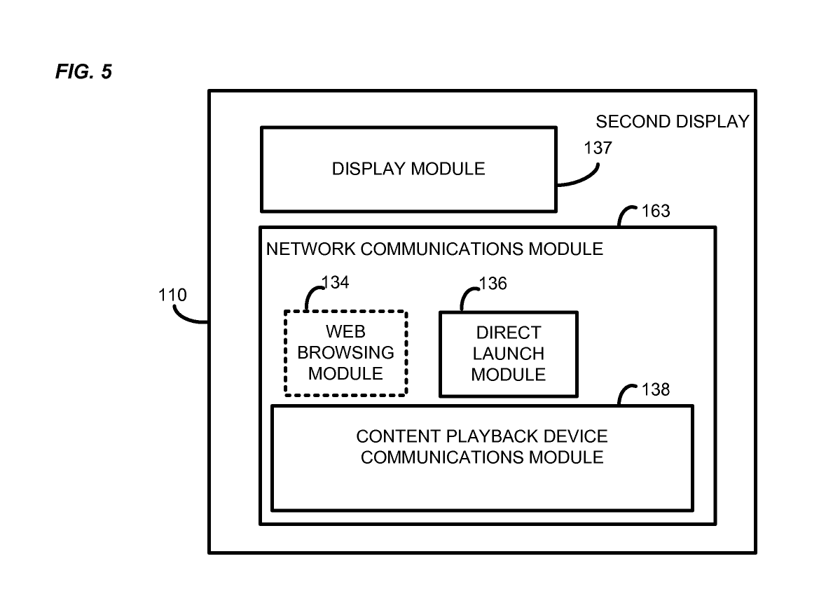

FIG. 5 illustrates one implementation of a second display 110. The second display 110 includes a display module 137 for use in, e.g., browsing a service and setting the same as a directly launched service. The display module 137 may also be employed in browsing lists and selecting items related to the content playback device. For example, a list of content playback devices accessible to the local network and/or addressable by the second display may be displayed using the display module 137, and the user may choose a content playback device from among them. In addition to choosing content playback devices, a user may review a list of accessible service providers using the display module 137. For example, such service providers may include those offering video-on-demand services for movies and other video content, audio content, or any number of other sites on which content may be browsed and selected. In one implementation, where a content playback device has been chosen, the results may be filtered based on the capability of the content playback device to render the content. In another implementation, the display module 137 may display not just content accessible to the local network, but also content resident on the local network, such as content stored on a digital video recorder or Blu-ray® player.

In some implementations, the display module 137 may be a module that produces an output signal for display by another device. In this case, the actual display may be external to the second display itself. For example, in the case of a Blu-ray® player being used as a second display, the display module 137 may be a unit that produces, e.g., an HDMI output signal, while the actual display may be performed by the TV that is connected to that HDMI output.

The second display 110 also includes a module for network communications 163 that allows the second display to communicate with the local network as well as, in some cases, specific devices directly. In particular, as part of the network communications module 163, a communications module 138 for communications with a content playback device is provided. The content playback device communications module 138 allows the second display to communicate with the content playback device either over the local network, via the internet, or directly. Such direct communications may include various types of wired or wireless transmission schemes, including WiFi, USB, infrared, Bluetooth®, or the like.

Also within the network communications module 163 may be an optional web-browsing module 134 through which the above-noted content items may be browsed in the case where the second display application is a web application. The web-browsing module 134 may be implemented in a number of ways, including by executing application code written in HTML, Javascript, or the like. A web-browsing module implemented in such a way allows the same to be implemented across many platforms, allowing any number of types of second displays to be employed. In some cases, special applications, e.g., helper applications, may be employed to communicate with particular proprietary or non-web-based technologies. Where the second display application is non-web-based, and is written in, e.g., native code, the web-browsing module 134 may be replaced with an analogous module allowing service and content selection and other functionality as has been described, e.g., for selection of content playback devices.

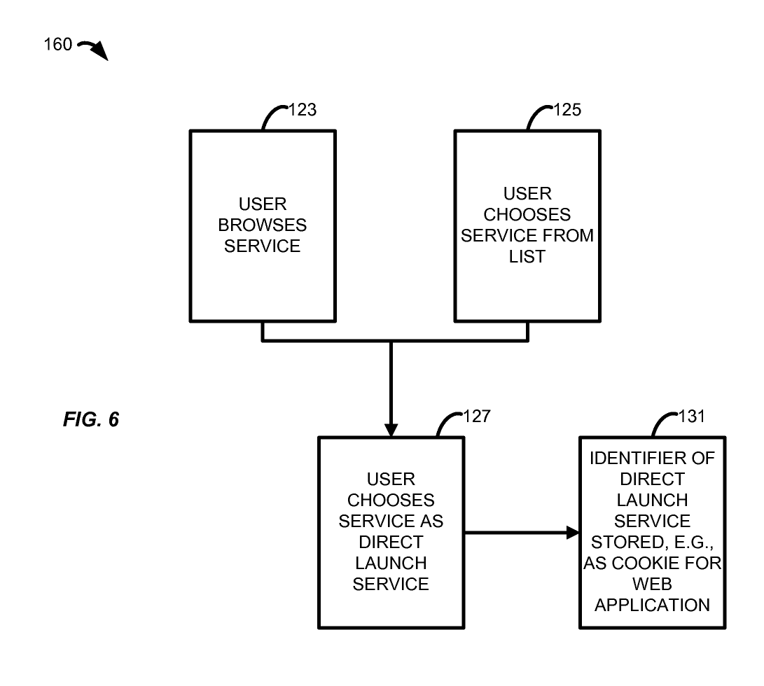

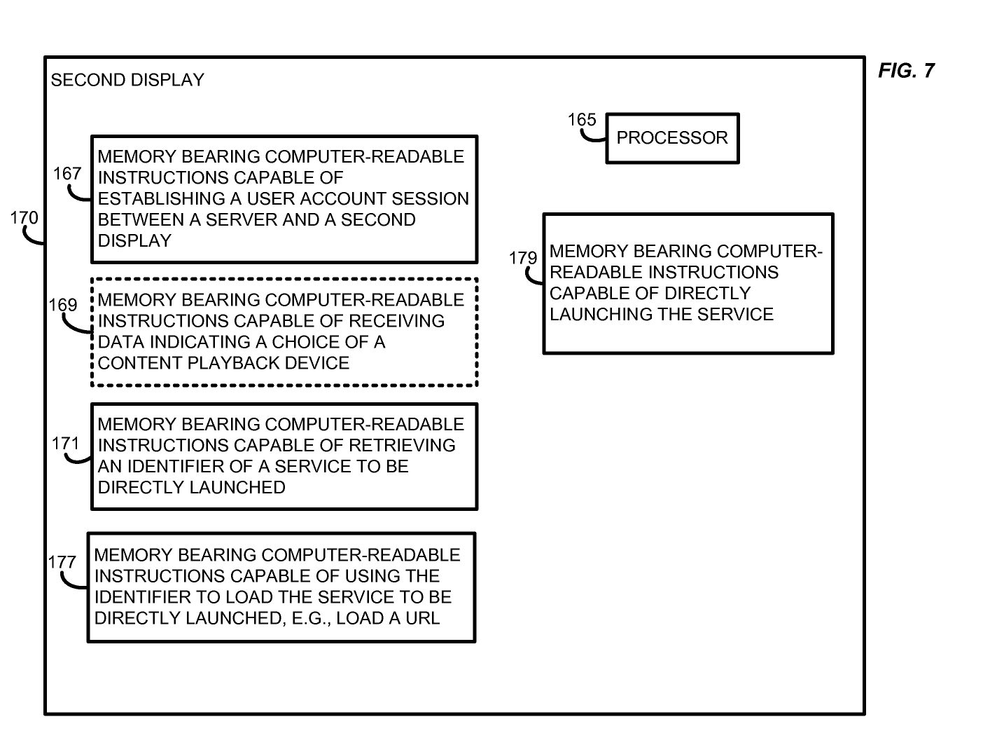

Also within the network communications module 163 may be a direct launch module 136. The direct launch module 136 may be employed to perform any of the steps, or a portion of such steps, in FIGS. 3 and 4, as well as below in FIGS. 6 and 7, e.g., retrieving information about a stored service and arranging for the same to be directly launched when the second display application is instantiated.

It is noted that the above modules may be implemented in hardware, non-transitory software, or a combination of the above. Typically, the same will be implemented within the context of a laptop computer, a tablet computer, a smart phone, or the like.

Referring to FIG. 6, a flowchart 160 is illustrated showing steps for creation of an identifier of a service to be directly launched. The identifier is then employed in the methods and systems above for a direct launch routine. In one implementation, a user may be browsing a service (step 123). From a button or menu item within their browser, the user may choose the service as a service to be directly launched (step 127). An identifier of the service to be directly launched is then stored (step 131). The storage may typically occur on the second display, although the same may be stored by the server, either in place of or in addition to the storage on the second display. In the case where the second display application is a web application, the identifier may be stored as a cookie for the web application. In an alternative embodiment, the user need not be currently viewing the service, but instead may choose the service to be directly-launched service from a list, menu, set of search results, or the like (step 125).

Referring to FIG. 7, an implementation of a second display 170 which may operate according to the principles described here is illustrated. In this implementation, the second display includes various memory locations bearing computer-readable instructions capable of performing various steps. First, the second display includes a processor 165 and memory 167 bearing computer-readable instructions capable of establishing a user account session between a server and a second display. The second display 170 may further include memory 169 bearing computer-readable instructions capable of receiving data indicating a choice of a content playback device. The choice may be made following display of the list of content playback devices, including those associated with a user account and those discovered separately, without access to the user account, in manners described above. However, no content playback device choice is necessary in all implementations. In many cases, the directly launched service will also include information about a preferred or default content playback device.

The second display 170 further includes memory 171 bearing computer-readable instructions capable of receiving or retrieving an identifier of a service to be directly launched. As noted, the identifier may be a cookie or other sort of data which the second display application can employ to identify a desired service. Where data has been received indicating a choice of a content playback device, this data may be employed by memory 171 to inform which service to directly launch. For example, the user may have set a desired music service to be directly launched when their second display application is focused on an audio receiver, and a desired video service to be directly launched when their second display application is focused on an IPTV.

The second display 170 further includes memory 177 bearing computer-readable instructions capable of using the identifier to load a URL of the service to be directly launched, as well as memory 179 bearing computer-readable instructions capable of causing the service to be directly launched.

Other memories will also be understood, including those with instructions which create shortcuts for services, those which include instructions for native remote controller applications, those which receive and display a list of services associated with the user account, those which filter a displayed service according to a category or the like, and those which provide for user selection of the service to be directly launched, among others.

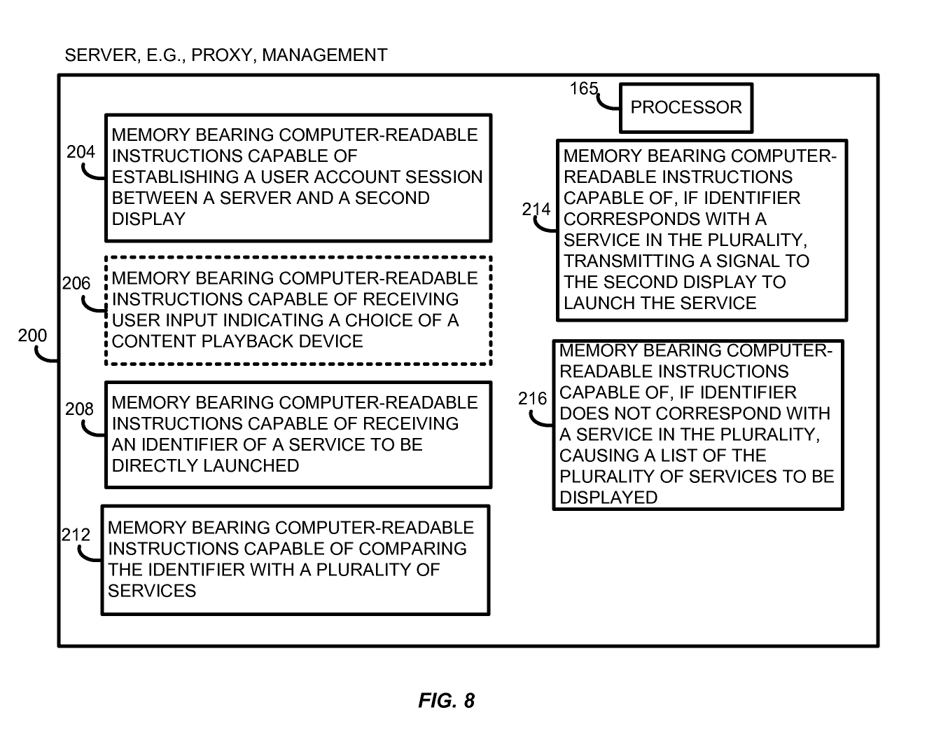

Referring to FIG. 8, an implementation of a server 200 is illustrated, and as in the case of the second display 170 includes various memories bearing computer-readable instructions capable of performing various steps. The server may be, e.g., a proxy server, a management server, or any other sort of server as described above. The server 200 includes a processor 201 and memory 204 bearing computer-readable instructions capable of establishing a user account session between a server and the second display. The server 200 may further include memory 206 bearing computer-readable instructions capable of receiving user input indicating a choice of a content playback device. The memory 206 need not be included in every implementation, but the same allows a modification of the selected directly-launched service to take account of a specific content playback device. Variations will also be understood. For example, the choice of a content playback device may be received in memory 206 in a number of ways, and not just by a contemporaneous user input. For example, a user may set a content playback device, or a set of content playback devices, as a default, and in that implementation the default content playback device may be employed to inform the decision of which service is directly launched.

The server 200 may further include memory 208 bearing computer-readable instructions capable of receiving an identifier of a service to be directly launched. In these instructions, the identifier is received from the second display, e.g., as a cookie, or from storage on the server. The server 200 may further include memory 212 bearing computer-readable instructions capable of comparing the identifier with the plurality of services. In many cases, the plurality of services may correspond to the services affiliated with the user account.

Where a content playback device has been specified, the plurality of services may be limited to services which may be played by the content playback device. The server 200 may further includes memory 214 bearing computer-readable instructions capable of, if the received identifier corresponds with a service in the plurality, transmitting a signal to the second display to cause the service to be launched. The same may be a signal that serves as a trigger to cause the second display application browser to be loaded with the appropriate URL, or may include URL information itself.

The server 200 may further include memory 216 bearing computer-readable instructions capable of, if the identifier does not correspond with the service in the plurality, causing a list of the plurality of services to be displayed. The list of the plurality may include services affiliated with the user account, those which may be potentially affiliated with the user account, or both. For services which may be potentially affiliated, the user may be prompted to create an affiliation with the service. In this way, memory 216 may serve the function of providing a way for a user to select an alternate service in the case where one does not directly launch. The server 200 may further include memory 218 bearing computer-readable instructions capable of filtering the data indicated or caused for display by the second display. Alternatively, this filtering may occur on the second display side. In this case, memory 218 serves the function of filtering the data on the server side, based on criteria such as the content playback device, on a category, or on other criteria.

Other memories will also be understood, although these are not specifically shown in FIG. 8. For example, memories may be provided which bear computer-readable instructions capable of causing category-specific information to be displayed within a service, or which are capable of retrieving an advertisement associated with the service and causing the advertisement to be launched.

In an alternative implementation, these memories as described above may be implemented as modules, either in software, hardware, or various forms of firmware. For example, a session module may be employed to establish user account sessions between the server and the second display. Various communications modules may be employed to, e.g., retrieve an identifier of a service to be directly launched, discover devices not already registered to the user account, use the identifier to load and launch the service, as well as to perform other functions noted above.

Systems and methods have been disclosed that allow improvement of the user experience of the IPTV without adding to the hardware costs of the unit. As disclosed above, users may employ the system and method to directly launch a service upon instantiation of a second display application. Using the described systems and methods, the user need not search through a potentially-long list of services to launch a desired service.

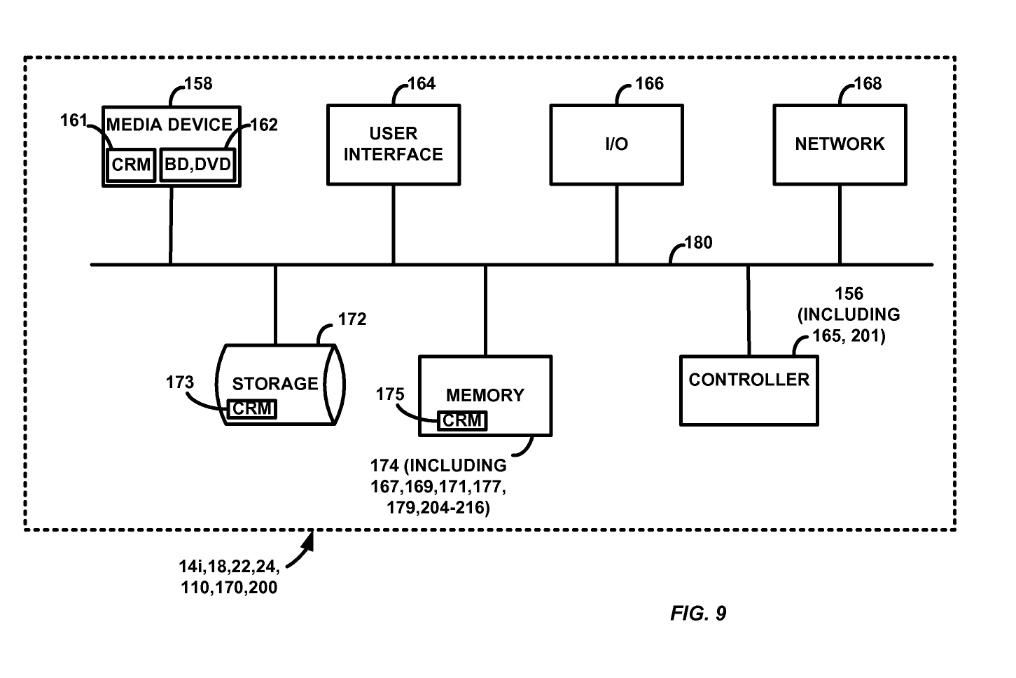

One implementation includes one or more programmable processors and corresponding computing system components to store and execute computer instructions, such as to execute the code that provides the second display or various server functionality, e.g., that of the proxy server 22, management server 18, and content server 24. Referring to FIG. 9, a representation of an exemplary computing environment for a second display or for any of the servers is illustrated.

The computing environment includes a controller 156, a memory 174, storage 172, a media device 158, a user interface 164, an input/output (I/O) interface 166, and a network interface 168. The components are interconnected by a common bus 170. Alternatively, different connection configurations can be used, such as a star pattern with the controller at the center.

The controller 156 includes a programmable processor and controls the operation of the second display and servers and their components. The controller 156 loads instructions from the memory 174 or an embedded controller memory (not shown) and executes these instructions to control the system. In its execution, the controller 156 may provide the second display control of a content playback device system as, in part, a software system. Alternatively, this service can be implemented as separate modular components in the controller 156 or the second display.

Memory 174, which may include non-transitory computer-readable memory 175, stores data temporarily for use by the other components of the second display 14i, and the same may include memories 167, 169, 171, 177, 179, and 204-216, as discussed above. In one implementation, memory 174 is implemented as RAM. In other implementations, memory 174 also includes long-term or permanent memory, such as flash memory and/or ROM.

Storage 172, which may include non-transitory computer-readable memory 173, stores data temporarily or long-term for use by other components of the second display and servers, such as for storing data used by the system. In one implementation, storage 172 is a hard disc drive or a solid state drive.

The media device 158, which may include non-transitory computer-readable memory 161, receives removable media and reads and/or writes data to the removable media. In one implementation, the media device 158 is an optical disc drive or disc burner, e.g., a writable Blu-ray® disc drive 162.

The user interface 164 includes components for accepting user input from the user of the second display, and presenting information to the user. In one implementation, the user interface 164 includes a keyboard, a mouse, audio speakers, and a display. The controller 156 uses input from the user to adjust the operation of the second display 14i.

The I/O interface 166 includes one or more I/O ports to connect to corresponding I/O devices, such as external storage or supplemental devices, e.g., a printer or a PDA. In one implementation, the ports of the I/O interface 166 include ports such as: USB ports, PCMCIA ports, serial ports, and/or parallel ports. In another implementation, the I/O interface 166 includes a wireless interface for wireless communication with external devices. These I/O interfaces may be employed to connect to one or more content playback devices.

The network interface 168 allows connections with the local network and optionally with content playback device 12 and includes a wired and/or wireless network connection, such as an RJ-45 or Ethernet connection or “WiFi” interface (802.11). Numerous other types of network connections will be understood to be possible, including WiMax, 3G or 4G, 802.15 protocols, 802.16 protocols, satellite, Bluetooth®, infrared, or the like.

The second display and servers may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and within the scope of the present invention. For example, while media content services have been focused on, the user may also browse services for other types of business or consumer transactions, such as video rentals, home shopping sites, or the like on the second display. The directly launched service may be an asset that is resident within the local network, e.g., content stored on a DVR or Blu-ray® player. In this case, no user account associated with a management server would be necessary. In addition, the second display may also include and manage information about other related devices, such as a media player and a game console.

While the system and method have described implementations in which content playback devices have been selected by a user before browsing, numerous other variations are possible. For example, a cache or cookie or other information may be employed to store information about content playback devices, so that no user choice is necessary. In another variation, a profile system may be employed that communicates content playback device information upon start-up according to a profile; e.g., a given content playback device may always be associated with and may authenticate itself with a given service provider. In this sense, a content playback device is still being chosen, but the choice does not require an affirmative step by the user. Use of any of these alternatives, or others, ensures that the content consumption of each content playback device is tracked. It further allows, as described, the proxy server to filter out content that the content playback device is incapable of playing. It is also noted that certain types of browsing may require no device choice at all, e.g., browsing shopping sites. Even in these implementations, some level of customization may occur, e.g., by consideration of the origination location of the visiting second display's IP address.

In addition, the above description was primarily directed to implementations in which the local IP address of the second display was retrieved and stored on the server. However, other ways of discovering the second display are also possible. For example, device discovery is also possible using a broadcast method within the local network. Compatible devices that recognize the broadcast message will respond with their necessary credentials and information to indicate their compliance with the application for the second display. In many cases, broadcasting methods are primarily directed to native applications, not web applications; however, a broadcasting library may be employed to allow the implementation even within a web application.

While the above description has focused on implementations where a second display is coupled to a content playback device through a local network or over the internet, it will be understood that the same will apply to any method by which the two may communicate, including 3G, 4G, and other such schemes.

Accordingly, the present invention is not limited to only those implementations described above.

1. A method of directly launching a service upon instantiation of a second display application, comprising:
i. upon instantiation of a second display application, establishing a session between a second display and a first server;
ii. retrieving an identifier of a service to be directly launched;
iii. using the identifier to load the service to be directly launched; and
iv. launching the service within the second display application.

2. The method of claim 1, wherein the second display application is a web application, and wherein the retrieving and using the identifier include:
i. adding a URL corresponding to the identifier as a GET parameter;
ii. loading HTML code with the GET parameter; and
iii. adding the HTML code as an autoexec variable in the web application.

3. The method of claim 2, further comprising clearing the autoexec variable upon launch of the service.

4. The method of claim 1, further comprising displaying a prompt for a user to create a shortcut associated with the service to be directly launched, and upon user input, creating the shortcut.

5. The method of claim 2, wherein the identifier is stored as a cookie.

6. The method of claim 1, wherein the second display application is a native remote controller application.

7. The method of claim 1, wherein the session is associated with a user account, the user account having associated therewith a plurality of services.

8. The method of claim 7, further comprising receiving and displaying a list of services associated with the user account.

9. The method of claim 1, further comprising retrieving data about a content playback device, and wherein the retrieved identifier of a service to be directly launched is in part determined by the data corresponding to the content playback device.

10. The method of claim 9, wherein the data about the content playback device is stored as a cookie.

11. The method of claim 1, wherein the identifier of a service to be directly launched includes category information, such that when the service to be directly launched is displayed for access on the second display, the displayed service is limited to the category.

12. The method of claim 1, wherein the service is a website.

13. The method of claim 1, wherein the identifier of a service to be directly launched is created by:
i. during a service browsing session, receiving an input from a user, the input indicating that a current service being browsed is to be designated as a service to be directly launched; and
ii. creating and storing an identifier corresponding to the service so designated.

14. The method of claim 1, wherein the service to be launched corresponds to an advertisement.

15. The method of claim 1, wherein the second display is a tablet computer, a smart phone, a laptop computer, a desktop computer, an internet appliance, or a computing device with internet access.

16. A non-transitory computer-readable medium, comprising instructions for causing a computing device to implement the method of claim 1.

17. A method of directly launching a service upon instantiation of a second display application, comprising:
i. establishing a session between a second display and a first server;
ii. receiving an identifier of a service to be directly launched;
iii. comparing the identifier of the service to be directly launched with a plurality of services;
iv. if the identifier of the service to be directly launched corresponds with a service in the plurality, transmitting a signal to the second display to cause the second display to launch the service corresponding to the identifier;
v. if the identifier of the service to be directly launched does not correspond with a service in the plurality, then:
1. causing a list of the plurality to be displayed on the second display; or
2. causing a browser on the second display to load and launch a registration website for the service corresponding to the identifier.

18. The method of claim 17, wherein the second display application is a web application, wherein the identifier of a service to be directly launched includes a URL corresponding to the service, and wherein the transmitted signal includes JavaScript code.

19. The method of claim 17, wherein the second display application is a native remote controller application.

20. The method of claim 17, wherein the identifier of a service to be directly launched includes category information, such that when the service to be directly launched is caused to be displayed on the second display, the displayed service is limited to the category.

21. The method of claim 17, wherein upon receipt of the identifier of the service to be directly launched, retrieving an advertisement associated with the identifier of the service to be directly launched, and causing the advertisement to be launched on the second display.

22. The method of claim 17, wherein the second display is a tablet computer, a smart phone, a laptop computer, a desktop computer, an internet appliance, or a computing device with internet access.

23. The method of claim 17, wherein the session is associated with a user account, the user account having associated therewith a plurality of services.

24. A non-transitory computer-readable medium, comprising instructions for causing a computing device to implement the method of claim 17.
